(19) United States
(12) Patent Application Publication
(10) Pub. No.: US 2003/0139962 A1
(43) Pub. Date: Jul. 24, 2003

(54) Web based sevice request and approval system

(76) Inventors: Francis H. Nobrega, Gardner, MA (US); Sachin G. Shah, Marlboro, MA (US)

Correspondence Address: CONLEY ROSE, P.C., P. O. BOX 3267, HOUSTON, TX, 77253-3267, US

(21) Appl. No.: 10/055,400

(22) Filed: Jan. 23, 2002

(51) Int. Cl. G06F 17/60

(52) U.S. Cl. 705/9; 709/206; 709/223

(57) ABSTRACT

The specification discloses a system and related method for automating entry and approval of service requests in a help-desk software environment. More particularly, services are selected by a requester from a series of predefined service category items in an online shopping cart format. When selected, each service item requiring approval initiates an electronic message to the one or more persons responsible for approving or denying the service request. The service requests are approved or denied by way of a web-based interface, and if approved, the service requests are then created as cases in the help-desk software.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The preferred embodiments of the present invention are directed to a web based service request and automated approval system. More particularly, the preferred embodiments are directed to a web based service request system in which services are selected from predefined categories by the requestor, and approvals by persons responsible are obtained electronically.

2. Background of the Invention

It has become common in the world of business to have Information Technology (IT) incident reports and work requests in an automated system for tracking purposes, known as help-desk software. One such help-desk software product is the Clarify eFront Office software produced by Amdocs Ltd.

In related art Clarify operations, customers (whether internal to the corporation or external), call a telephone number and are connected to a help-desk operator. The customer explains the service problem and the help-desk operator keys in the problem or request in free-form mode. Examples of possible problems or requests could be service related to computers, for example hardware failures, or the possible problems could be associated with operation of a particular software program. The customer may also place a service request, for example the creation of an electronic mail account, a user account on the company's network, and the like.

Generally in the related art, the individual keying in the customer's complaint or service request creates what is known as a “case” in the Clarify system. If the case is a trouble report related to hardware or software, it is unlikely that any form of approval is required before a service technician addresses the problem. If, however, the case is a request for creation of new services, for example creation of an SAP account in multiple modules, relocation of computer hardware, creation of a new electronic mail account, and the like, it is likely that some form of approval will be required.

In related art systems, after creation of the case in the help-desk software, approvals are generally acquired by an individual contacting each required approver in the approval chain. This is a manual process, and depending on the number of approvers in the approval chain, may take many hours or even days. If the requested service is not approved, an individual (whether the help-desk operator or the service technician) must close the case in the Clarify system.

As can be appreciated from the above description, the process, while being automated to some extent, still requires significant human intervention. This is especially true when entering the information to create a case in the help-desk software system such as the Clarify system, and is also true in the approval process. What is needed in the art is a way to streamline the case entry and approval process.

### BRIEF SUMMARY OF SOME OF THE PREFERRED EMBODIMENTS

The problems noted above are solved in large part by a method and related system of automating the entry and approval process for cases in Clarify or Clarify-type help-desk software systems. In the preferred embodiments, customers (whether internal or external) input their request by way of a web-based system. This alleviates an aspect of the need for a help-desk operator. Further, rather than inputting the information in a free-form style, the customer is allowed to select from previously defined services and service categories in a fashion similar to an on-line shopping cart system. Once the customer has finished making the desired selections, the customer submits the request.

After submission, the one or more requests are analyzed for their particular requirements, which are also preferably predefined. To the extent a request does not require financial or technical approval, the request is submitted to the help-desk software, preferably the Clarify software system, for creation of a case. If, however, the customer's request requires approval, preferably the person or persons responsible for approving that request are sent an electronic mail notification containing a clickable link to a web-based approval site. Once all the necessary approvals are obtained, preferably the system creates a case in the Clarify system. In the event that one or more approvals are denied, preferably the system electronic mails the customer that his/her request has been denied.

In this way, the entry process is automated in a familiar online shopping cart format, eliminating the need for a person to transcribe information into the Clarify system. Moreover, a case is not created in the Clarify system until all the necessary approvals, if any, are obtained. Relatedly, the approval system is automated, thus eliminating the need for a help-desk operator or technician servicing the cases to be responsible for verifying approval for the request before performing the desired tasks.

### BRIEF DESCRIPTION OF THE DRAWINGS

For a detailed description of the preferred embodiments of the invention, reference will now be made to the accompanying drawings in which:

FIG. 1 shows, in block diagram form, the various components of the preferred embodiments;

FIG. 2 shows an exemplary web-based screen showing selection of services from predefined categories;

FIG. 3 shows an exemplary web-based screen showing service catalog summary information for an exemplary predefined service; and

FIG. 4 shows a flow diagram of the preferred service selection, approval and case creation method.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . .”.

### DESCRIPTION OF THE PREFERRED EMBODIMENTS

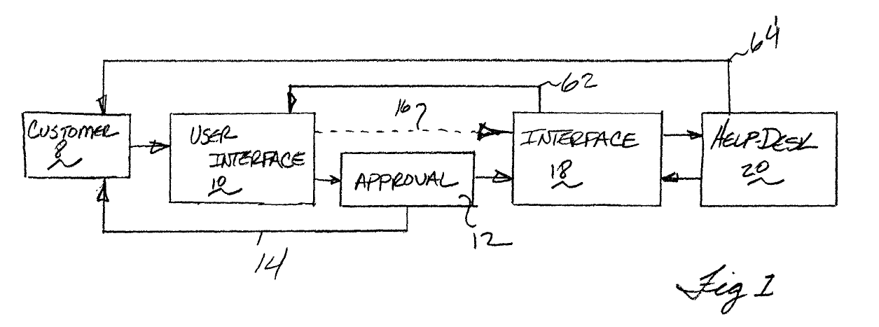

The preferred embodiments of the present invention are directed to automating the process of entering cases in a help-desk software system. The preferred embodiments may be logically, though not necessarily physically, divided into four major components. FIG. 1 shows these four logical components of the preferred embodiment (user interface 10, approval component 12, help-desk software interface 18 and help-desk software 20), and how generally they interact.

In particular, customers or requestors access the system by way of a user interface component 10. It is within the user interface component 10 that the customer or requester enters a specific request, which is discussed more thoroughly below. The results of the customer entering the request in the user interface 10 are transferred to an approval component 12. The approval component 12 is preferably responsible for notifying approvers and gathering approval or denial information. If the request is denied, the approval logic 12 generates an electronic mail (e-mail) message to the customer or requestor 8 indicating the denial of the request, as indicated by line 14 of FIG. 1. It is possible, however, that a particular service request does not require approval, and thus the approval component 12 may be skipped in its entirety as indicated by dashed line 16 of FIG. 1. The next logical component is the help-desk interface component 18 which gathers its information from the approval component 12. The interface logic 18 preferably handles communicating to and from the help-desk software 20. The help-desk software 20 may be any available help-desk type software for managing information technology or related issues. In the preferred embodiment, the help-desk software 20 is the Clarify software program offered by Amdocs Ltd. One of ordinary skill in the art is familiar with the use of Clarify and Clarify-type help-desk software programs.

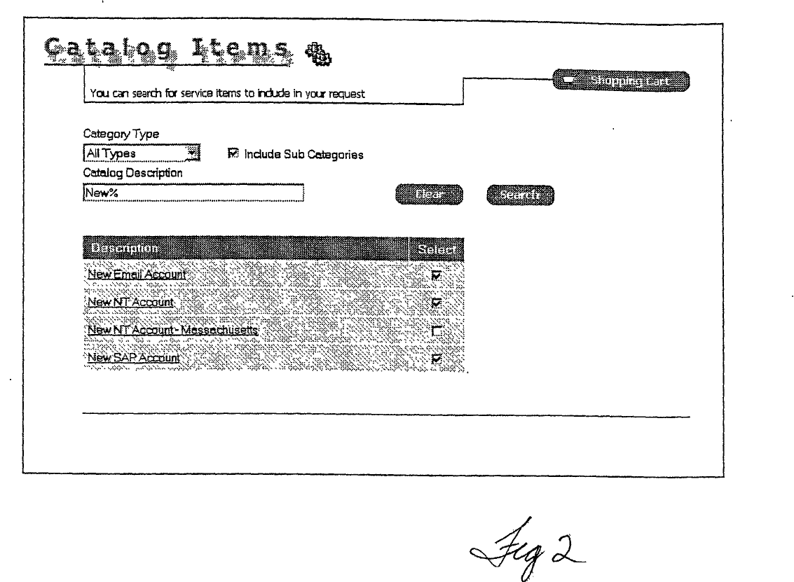

The user interface component 10 is preferably accessed by the customer or requestor by way of a web-based interface. In this way, the requester or customer need only have access to the internet and standard web browser to enter service requests. Preferably, the user interface component 10 operates on principles similar to on-line shopping software, also known as Shopping Cart software. In particular, preferably service requests are entered by interactively selecting and holding service request items from pre-defined lists for prospective submission. FIG. 2 shows an exemplary user interface screen from which a customer may select service catalog items. FIG. 2 exemplifies the preferred catalog format service requesting by showing four service requests identified in a catalog description search using the search string “New %” where the “%” is a wild-card identifier. In this exemplary system, four service catalog items were identified, namely: new electronic mail account, new NT account, new NT account—Massachusetts, and new SAP account. Although only four such service catalog items are shown in FIG. 2, it must be understood that many service catalog items may be available to the customer in the preferred embodiments. These service catalog items may also comprise requesting repair of particular hardware (also providing a field for a brief description of the problem), requests for relocation of hardware devices such as computers and printers (also providing a field for a description of the new and old locations), and the like. FIG. 2 also exemplifies that a requestor or customer may, in the preferred embodiments, select multiple services from the service catalog items in any one session.

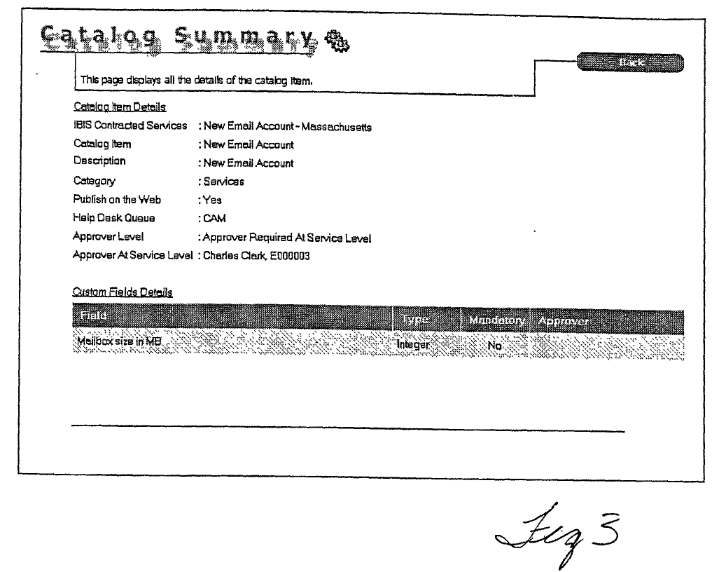

Preferably, each service catalog item has a set-up screen which defines important characteristic of the service in the overall system. FIG. 3 exemplifies a service catalog summary screen that shows the pertinent information associated with a service catalog being a New Electronic Mail Account—Massachusetts. The New Email Account—Massachusetts is allowed to be published on the web and is assigned a help-desk queue “CAM.” As one of ordinary skill in the art is aware, queues in the help-desk software are where cases are placed for servicing, typically in a first-in first-out manner. This exemplary catalog summary screen on a New Email Account—Massachusetts also indicates that approval is required for this particular service catalog item. Finally, though preferably the services are selected from service catalog items, it may be necessary in some cases to provide additional information so that the service may be fulfilled. In the exemplary case shown in FIG. 3, the additional information needed is the size of the mailbox requested. In other cases, for example, relocation of a computer from one location to another, it may be necessary to input additional information in the form of the name of the computer and current location, as well as the destination location of the computer. One of ordinary skill in the art, now understanding the concept of selecting computer related services through a service catalog item list could easily create many service catalog items, including fields for entry of service-specific information, without departing from the scope and spirit of this invention.

After selecting the service or services desired from the catalog, and entering any necessary information associated with any of the service catalog items, preferably the customer or requestor proceeds to a submission or check-out stage, where the customer may have the opportunity to review again the services requested, and remove any of those services that the customer deems are no longer necessary. Once final changes are made, if any, the customer “checks out” or submits the request.

As alluded to above, some requests may need approval prior to performing the services desired. Referring again to FIG. 1, the user interface component 10 preferably submits the request generated to the approval component 12. In broad terms, the approval component 12 is responsible for electronically gathering approvals for service catalog item requests. More particularly, the approval component 12 preferably analyzes the service request passed by the user interface component 10. If the service requests entered do not require approval, effectively the approval component 12 is by-passed, as symbolically indicated by dashed line 16. If, however, one or more of the services selected requires approval, the approval component 12 preferably generates an e-mail message to that approver, and includes in the text of that electronic mail message a URL link to a web site. Preferably, the approver receives the e-mail, clicks the hyperlink to the URL provided and approves or denies the request.

It should be understood that the approval process may take different forms for different service requests, and indeed may vary between different companies. For example, for some service requests, only technical approval may be required. For other service requests, for example the relocation of a computer system, both a financial approval and a technical approval may be required. Further still, in some organizations, the approval chain may be hierarchical, and thus the approval component 12 may be responsible for sending a plurality of electronic mails to different approvers, one at a time, sending the next e-mail if the previous approver approves the service request in question.

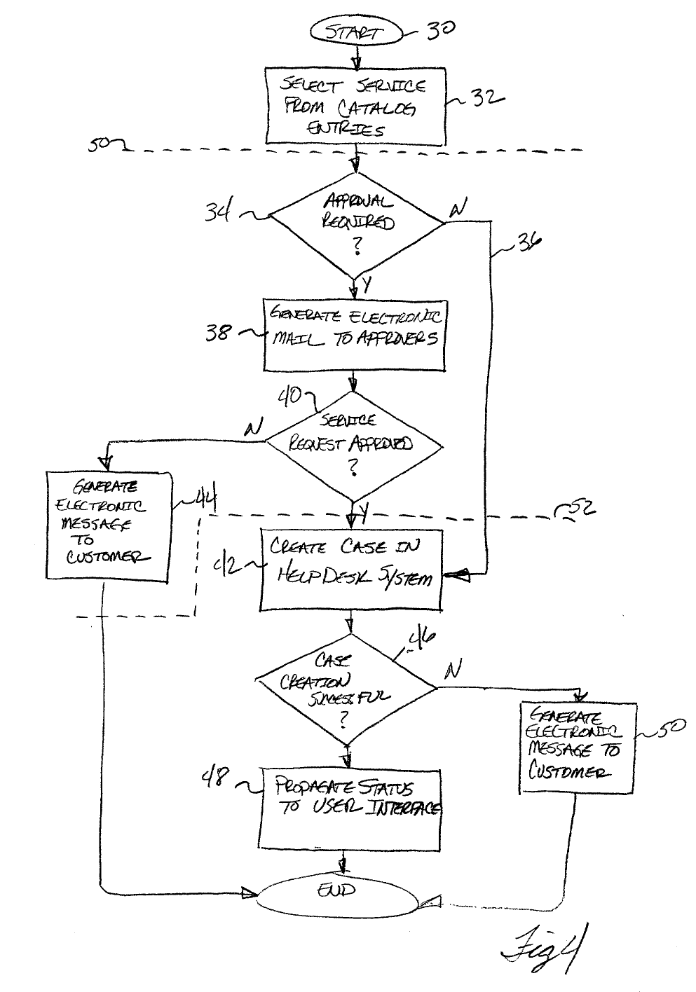

FIG. 4 shows a flow diagram of the service entry process of the preferred embodiment. In particular, the process starts at step 30 and progresses to a customer selecting services from the catalog entries (step 32). Selecting services from the catalog entries preferably takes place in the user interface component 10, as shown in FIG. 1.

After selection of the desired service catalog items, a decision is made regarding whether the services selected require approval (step 34). If no approval is required for the service or services selected by the requester, then the procedure proceeds along line 36 to step 42, which is discussed more thoroughly below. If, however, approval for a service request is required, preferably the next step is the generation of electronic mail messages which are sent to the predetermined approvers (step 38). Preferably, the electronic messages contain a link to a URL which takes the approver to a web based location where he or she can approve or deny the request. After generation of the electronic mail messages to the approvers in step 38, the next step is the determination as to whether the particular service request or requests have been approved (step 40). In the preferred embodiments, each service request is handled independently. Thus, if a requestor selects two services, one of which requires approval and a second that does not, then preferably the procedure exemplified in FIG. 4 bypasses the approval process for that service or services that do not require approval (line 36). The service or services that do require approval, however, enter the approval process (steps 38 and 40). Thus, in the preferred embodiments, though services may be selected substantially simultaneously, each service selected becomes an independent case, an independent tracking entry, in the preferred Clarify help-desk software.

If the particular service request is approved as determined at step 40, the process proceeds to step 42, where a case for the service is created in the help-desk system. If, however, the approval is denied, the process proceeds to step 44 where an electronic message is generated to the customer indicating that the requested service has been denied. Before proceeding, it must be understood that the preferred embodiments of the present invention are not limited to any particular type of approval process. As discussed above, there may only be a single level of approval, for example, a technical approval. Likewise, there may be both financial and technical approval, which may be the same or different people. Moreover, the approval process may be hierarchical at both the financial and technical levels such that the generation of electronic mail approvals in step 38 and evaluation as to approval of disapproval in step 48 may be serially repeated for each person in the approval chain.

If the service selected does not require approval, or if approval has already been obtained through the use of steps 38 and 40, the next step in the preferred embodiment is the creation of the case in the help-desk system. In the preferred embodiments, the help-desk system is a Clarify help-desk program produced by Amdocs Ltd. If case creation is successful in the help-desk system (step 46), then the case creation status is preferably propagated back to the user interface component 10 (step 48). In this way, the requestor or customer need merely check the status to obtain a case number in the help-desk system, for example for tracking purposes. If however, creation of the case was unsuccessful in the help-desk software, preferably an electronic message is generated to the customer or requester indicating the failure of their request.

Referring somewhat simultaneously to FIGS. 1 and 4, those steps performed by the user interface component 10 of the preferred embodiment are the selection of the service from the catalog entries step above dashed line 50 of FIG. 4. The approval component 12 preferably implements the steps between dashed lines 50 and 52 of FIG. 4, in particular steps 34, 38, 40 and 44. Line 14 of FIG. 1 is exemplary of generating the electronic message to the customer upon a denial of the service request at step 44. The steps of FIG. 4 below line 52 are preferably implemented in a combination of the interface component 18 and the help-desk software 20. In particular, propagating the status of the case creation to the user interface component (step 48) is exemplified by line 62 of FIG. 1. Likewise, line 64 is exemplary of the help-desk software 20 generating an electronic message to the customer upon a failure of creation of the case in the help-desk system (step 50).

In the preferred embodiments, the user interface module is preferably a software program written in one or both of the ASP or HTML programming language. Generating electronic mail to approvers seeking their approval or denial of a service request, as well as evaluating those responses, in the preferred embodiments is developed using Microsoft Technology, particularly Microsoft Visual Interdev Studio development environment. Finally, the interface component 18 is preferably written in Microsoft Visual Studio. However, while these are the preferred languages for implementing the various tasks described, one of ordinary skill in the art, now understanding the procedures and requirements of the system, could easily design equivalent systems in these or different programming languages.

The above discussion is meant to be illustrative of the principles and various embodiments of the present invention. Numerous variations and modifications will become apparent to those skilled in the art once the above disclosure is fully appreciated. For example, it is envisioned that all the software components used to implement the preferred embodiments will be stored and executed on a single computer system; however, each individual component may reside on an individual computer or server system linked by communication networks, and such a system would still be within the contemplation of this invention. Further, there may be many help-desk type software systems available on the market, and each of those help-desk type systems could be equivalently used in the embodiments described. While each of the various components of the preferred embodiment are described as individual software components, it is possible that the functionality embodied in all the various components may be written into or contained in a single software program, and this too would be within the contemplation of this invention. It is intended that the following claims be interpreted to embrace all such variations and modifications.

What is claimed is:

1. A method of entering service requests in a help-desk software system, the method comprising:
using a web browser to select a service request from a set of predefined service requests; and
creating a case for the service request in the help-desk software system.

2. The method of entering service requests in a help-desk software system as defined in claim 1 further comprising, before the creating a case step, seeking an approval for the service request by way of a web based approval system.

3. The method of entering service requests in a help-desk software system as defined in claim 2 wherein seeking an approval for the service request by way of a web based approval system further comprises:
sending electronic mail to a person responsible for approval of the service request, the electronic mail comprising a link to a web based approval system;
selecting one of approval or denial of the request from the web based approval system; and
creating a case for the service request in the help-desk software system only if the service request is approved.

4. The method of entering service requests in a help-desk software system as defined in claim 1 wherein using a web browser to select a service request from a set of predefined service requests further comprises selecting the service request from the set of predefined service requests using an online shopping cart system.

5. A computer system for entry of a service request into a help-desk software program, the computer system having software components comprising:
a web based user interface component, and wherein the web based user interface component allows a user to select the service request from a list of predefined service requests;
an approval component in data communication with the user interface component, the approval component seeks approval for the service request if required;
a help-desk software program that tracks service requests; and
a help-desk interface component in data communication with the approval component and the help-desk software program, the help-desk interface component creates cases in the help-desk software program.

6. The computer system as defined in claim 5 wherein the web based user interface component is further adapted to allow a user to interactively select and hold service requests from a list of predefined service requests for prospective submission.

7. The computer system as defined in claim 5 wherein the approval component is further adapted to seek approval for the service request electronically.

8. The computer system as defined in claim 5 wherein the help-desk software program further comprises a Clarify eFront Office software program produced by Amdocs Ltd.

9. In a help-desk software environment for tracking service requests, a method of entering a service request comprising:
accessing a predefined list of available services by way of an internet browser program;
choosing a first service request from the predefined service list of available services;
choosing a second service request from the predefined service list of available services; and
creating a case for each of the first and second service requests in the help-desk software.

10. The method of entering a service request as defined in claim 9 further comprising, before the creating a case step, seeking an approval of at least one of the first and second service requests by way of a web based approval system.

11. The method of entering a service request as defined in claim 10 wherein seeking an approval of at least one of the first and second service requests by way of a web based approval system further comprises:
sending electronic mail to a person responsible for approval of the first service request, the electronic mail comprising a link to the web based approval system; and
selecting one of approval or denial of the first request from the web based approval system.

12. The method of entering a service request as defined in claim 11 wherein creating a case for each of the first and second service requests further comprises creating a case for the first service request in the help-desk software system only if the first service request is approved in the selecting step.

13. The method of entering a service request as defined in claim 12 wherein seeking an approval at least one of the first and second service requests by way of a web based approval system further comprises:
sending electronic mail to a person responsible for approval of the second service request, the electronic mail comprising a link to the web based approval system; and
selecting one of approval or denial of the second request from the web based approval system.

14. The method of entering a service request as defined in claim 13 wherein creating a case for each of the first and second service requests further comprises creating a case for the second service request in the help-desk software system only if the second service request is approved in the selecting step.

15. The method of entering a service request as defined in claim 9 wherein the accessing a predefined list of available services, choosing a first service request and choosing a second service request further comprises:
viewing at least a portion of the predefined list of available services;
interactively selecting and holding the first and second service requests in an online shopping cart; and thereafter
submitting the selected first and second service requests.

16. A method of entering computer related service requests in a help-desk software case tracking system comprising:
selecting a computer related service request from a list of available service requests, the selecting in an online shopping cart format;
seeking approval for the computer related service request electronically; and
creating a tracking entry in the help-desk software for the selected computer related service if the computer related service is approved.

17. The method of entering computer related service requests in a help-desk software case tracking system as defined in claim 16 wherein seeking approval for the computer related service request electronically further comprises:
notifying a person responsible for approval of the computer related service request that an approval is required by an electronic mail message; and
selecting one of approval or denial of the computer related service request by way of a web based interface.

18. The method of entering computer related service requests in a help-desk software case tracking system as defined in claim 16 wherein creating a tracking entry in the help-desk software for the selected computer related service if the computer related service is approved further comprises creating the tracking entry without human assistance.
